(19) United States
(12) Patent Application Publication
(10) Pub. No.: US 2013/0234650 A1
(43) Pub. Date: Sep. 12, 2013

(54) CHARGER HAVING A RETRACTABLE SEAT

(71) Applicant: Hung-Chang Liu, New Taipei City (TW)

(72) Inventor: Hung-Chang Liu, New Taipei City (TW)

(21) Appl. No.: 13/412,917

(22) Filed: Mar. 6, 2012

(51) Int. Cl. H02J 7/00

(52) U.S. Cl. 320/107

(57) ABSTRACT

A charger having a retractable seat has a body and a seat. The body has a receiving slot formed therein to communicate with an opening formed through one side of the body. The seat is movably mounted in the receiving slot and has a blocking portion formed on one end of the seat extendable beyond the opening of the body for holding an electronic device between the blocking portion and the body. A first multi-sectional position limiting member formed in at least one inner wall of the receiving slot slidably engages the second multi-sectional position limiting member at multiple positions of the first multi-sectional position limiting member so that users can pull the seat a length out of the receiving slot to properly carry an electronic device on the seat in accordance with the size of the electronic device.

### BACKGROUND OF THE INVENTION

1. Field of the Invention

The present invention relates to a charger having a retractable seat and more particularly to a charger having a retractable seat for an electronic device to be charged to rest on the seat and allowing the seat to be pulled out a length by users based on the size of the electronic device.

2. Description of the Related Art

Due to prevalence of portable electronic devices, such as smart phones, tablet personal computers and the like, almost everyone carries at least one portable electronic device. As current battery technology is still infeasible to implement a battery with compact size but durable battery life, most portable electronic devices at present tend to have batteries embedded therein so as to eliminate the trouble of battery replacement and directly charge the portable electronic devices by chargers instead. Hence, the power of the batteries can be supplemented and the portable electronic devices can be still operated when the batteries therein are being charged.

Chargers in the market can be roughly classified as accessory chargers and power banks. The accessory chargers are the charging devices coming with portable electronic devices when the portable electronic devices are bought. Each accessory charger has a power input port and a power output port. The power output port serves to be electrically connected with a corresponding portable electronic device. When the power input port is connected to the AC mains, the portable electronic device is charged by the mains power. Each power bank also has a power input port and a power output port. The power input port serves to acquire power and charge a rechargeable battery pack in the power bank. When a corresponding portable electronic device is connected to the power output port of the power bank, the rechargeable battery pack of the power bank charges the portable electronic device through the power output port.

Most new portable electronic devices are equipped with functions for users to easily browse information or surf the Internet. However, as the portable electronic devices must be connected with chargers during the charging process, it is inconvenient for users to hold the portable electronic devices and operate them to browse information and surf the Internet.

### SUMMARY OF THE INVENTION

An objective of the present invention is to provide a charger for an electronic device to be rested on a retractable seat so that the electronic device can be operated without requiring a hand to hold the electronic device.

To achieve the foregoing objective, the charger has a body and a seat.

The body has a power input port, a power output port, a receiving slot and an opening. The power input port is adapted to connect to and acquire power from the AC mains. The power output port is adapted to connect to an electronic device. The receiving slot is formed in and recessed from one side of the body and has a first multi-sectional position limiting member formed in at least one inner wall of the receiving slot. The opening is formed through the side of the body to communicate with the receiving slot.

The seat is movably and retractably mounted in the receiving slot, and has a blocking portion and a second multi-sectional position limiting member. The blocking portion is formed on and protrudes upwardly from one end of the seat extendable beyond the opening of the body. The second multi-sectional position limiting member slidably engages the first multi-sectional position limiting member at multiple positions of the first multi-sectional position limiting member.

With the charger having a retractable seat, when an electronic device is to be charged by the charger, the seat can be pulled out of the receiving slot for the electronic device to be rested on the seat. Furthermore, the seat of the charger can be pulled out a length in response to a size or a shape of the electronic device so that the electronic device can be firmly rested on the seat. To facilitate users' browsing and viewing a display of the electronic device, the seat can be also adjustably pulled out of the receiving slot for the electronic device to be oriented in an intended direction.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a charger having a retractable seat in accordance with the present invention;

FIG. 2 is a partially exploded perspective view of the charger in FIG. 1;

FIG. 3 is a top view in partial section of the charger in FIG. 1;

FIG. 4 is an operational perspective view of the charger in FIG. 1 when an electronic device is rested on a retractable seat of the charger;

FIG. 5 is another operational perspective view of the charger in FIG. 1 when another electronic device is rested on the retractable seat of the charger;

FIG. 6 is an operational side view in partial section of the charger in FIG. 4;

FIG. 7 is a perspective view of a second embodiment of a charger having a retractable seat in accordance with the present invention;

FIG. 8 is a side view in partial section of the charger in FIG. 7; and

FIG. 9 is a partially exploded perspective view of a third embodiment of a charger having a retractable seat in accordance with the present invention.

### DETAILED DESCRIPTION OF THE INVENTION

The charger having a retractable seat in accordance with the present invention may be a charger of a regular electronic device or a power bank whose difference lies in that the charger has a charging circuit mounted therein and the power bank has a rechargeable battery pack mounted therein and is not further described here for being common knowledge known to persons in the related technical field. Power banks are employed to describe the following embodiments of the present invention.

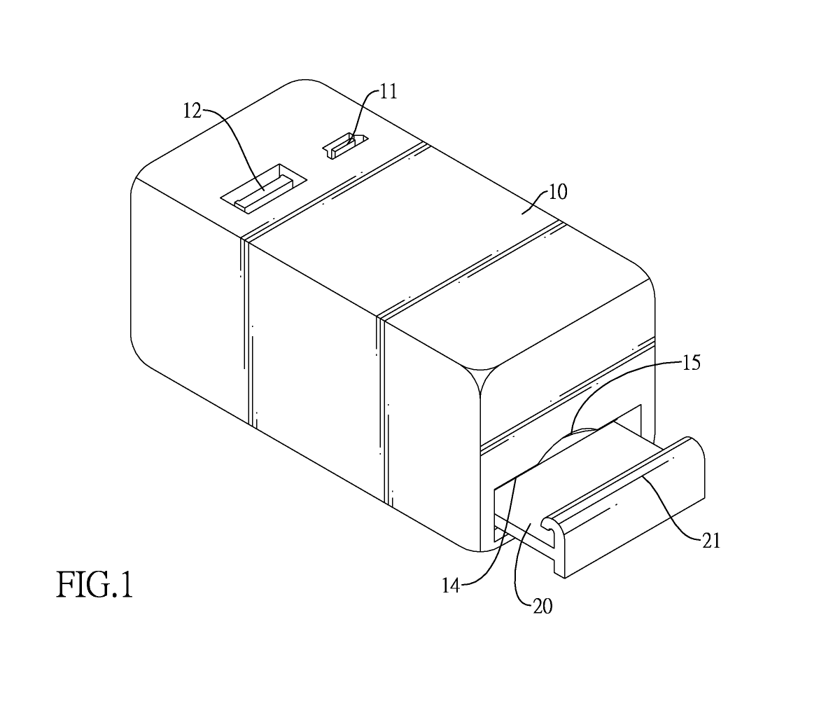

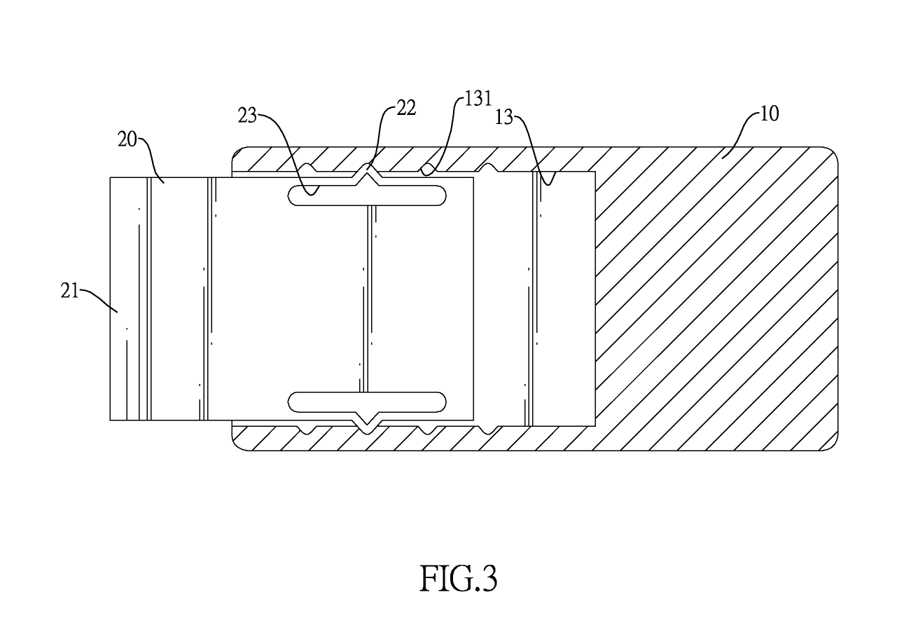

With reference to FIGS. 1 to 3, a first embodiment of a charger having a retractable seat in accordance with the present invention has a body 10 and a seat 20.

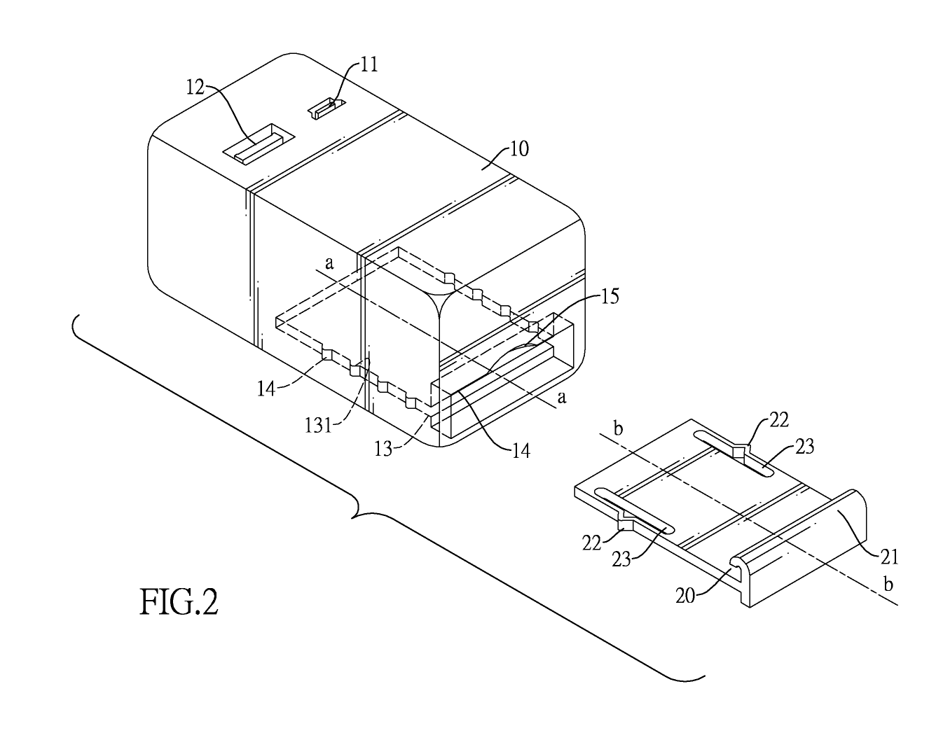

The body 10 has a power input port 11 and a power output port 12. The power input port 11 serves to connect to and acquire power from the AC mains. With reference to FIG. 2, the body further has a receiving slot 13, an opening 14 and a depressed portion 15. The receiving slot 13 is formed in and recessed from one side of the body 10 and has a first multi-sectional position limiting member. In the present embodiment, the first multi-sectional position limiting member has multiple notches 131 respectively formed in two opposite inner walls of the receiving slot 13. At least two of the notches 131 are formed in each of the opposite inner walls of the receiving slot 13, and the notches 131 in the opposite inner walls of the receiving slot 13 are symmetrical to each other with respect to a center line a-a of the receiving slot 13, which is parallel to the opposite inner walls of the receiving slot 13. The opening 14 is formed through the side of the body 10 to communicate with the receiving slot 13. The depressed portion 15 is formed in and recessed from one edge of the opening 14.

The seat 20 is movably mounted in the receiving slot 13, and has a blocking portion 21 and a second multi-sectional position limiting member. The blocking portion 21 is formed on and protrudes upwardly from one end of the seat 20 extendable beyond the opening 14 of the body 10. The second multi-sectional position limiting member slidably engages the first multi-sectional position limiting member at multiple positions of the first multi-sectional position limiting member. The blocking portion 21 takes the form of a hook. One free end of the blocking portion 21 is bent toward the body 10. In the present embodiment, the second multi-sectional position limiting member has multiple ridges 22. The ridges 22 are respectively formed on and protrude from two opposite sides of the seat 20, are symmetrical to each other with respect to a center line b-b of the seat 20, which is parallel to the opposite sides of the seat 20, and slidably engage the respective notches 131. The seat further has multiple through slots 23 formed through the seat and adjacent to the respective ridges 22.

The seat 20 is operated to be retractable within the receiving slot 13 as follows.

1. When the seat 20 is fully inserted into the receiving slot 13, the ridges 22 engage the respective innermost notches on the two opposite walls of the receiving slot 13 so as to position the seat 20.

2. If intending to pull the seat 20 out of the receiving slot 13, users can use a finger to exert a force on the seat 20 through the depressed portion 15 of the body 10 so that the seat 20 is partially moved out of the receiving slot 13 for users to easily pull the seat 20 out. In the present embodiment, the body 10 has only one depressed portion 15. The body 10 having multiple depressed portions 15 can achieve the same and is not further described here.

3. When the seat 20 is moved in a direction away from the receiving slot 13, the ridges 22 on two sides of the seat abut against the respective inner walls of the receiving slot having no notches 131 formed therein and the ridges 22 are resiliently squeezed toward a central portion of the seat 20 so that the seat 20 is movable inside the receiving slot 13.

4. When the seat 20 keeps moving in the direction away from the receiving slot 13, the ridges of the seat 20 further engage other notches 131 on the respective inner walls of the receiving slot 13 to position the seat 20 again.

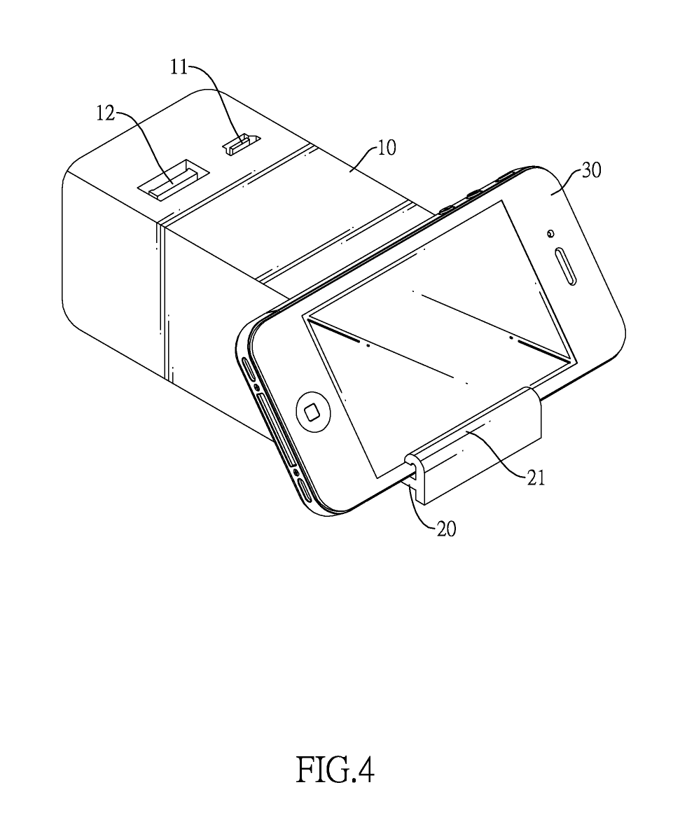

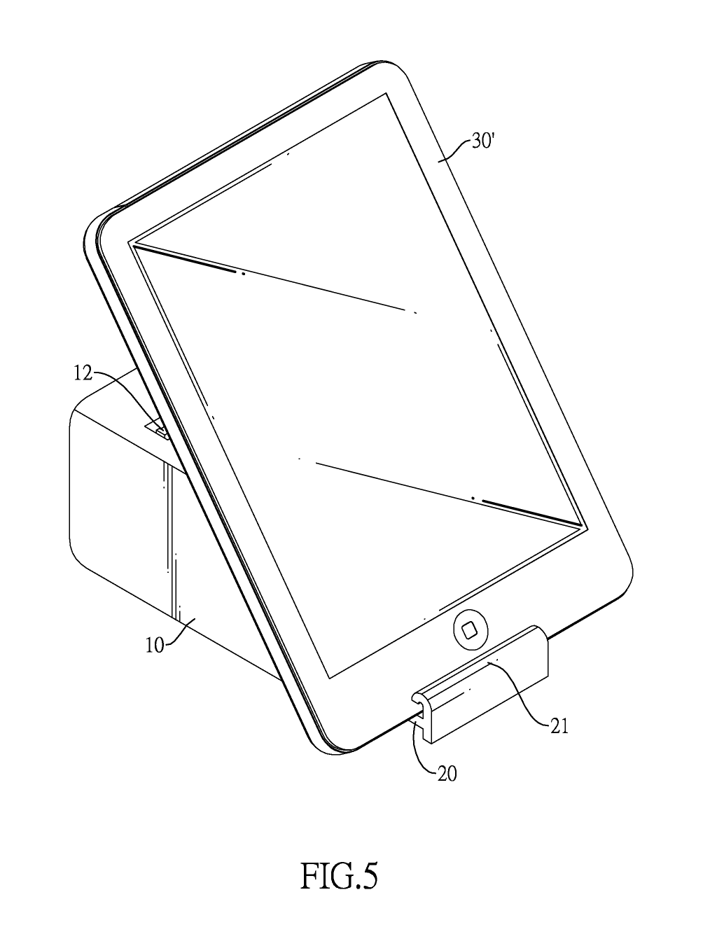

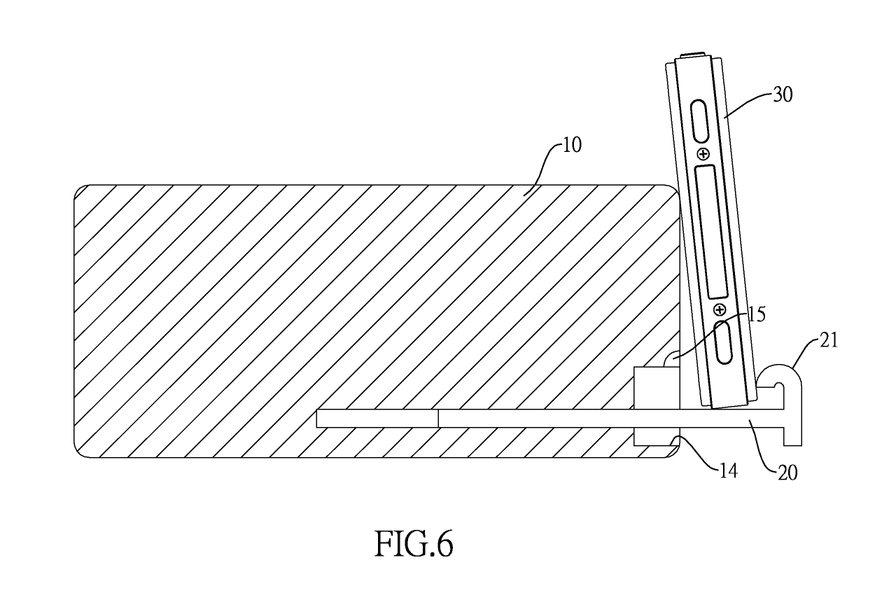

When using the first embodiment of the charger, users can connect the power output port 12 and an electronic device to be charged with a connection wire to charge the electronic device. With reference to FIG. 4, the seat 20 that is movably mounted inside the receiving slot 13 is pulled out from the receiving slot 13 so that an electronic device 30 can be rested on the seat 20. The electronic device 30 is held and fixed between the blocking portion 21 and the body 10. With reference to FIG. 5, The slidable engagement provided by the first multi-sectional position limiting member formed in the inner walls of the receiving slot 13 and the second multi-sectional position limiting member formed on the seat 20 renders a multi-sectional position limiting function. Based on a different demand, such as an electronic device 30′ having a different size, a length of the seat 20 pulled out of and extending outwardly from the opening 14 of the body 11 is adjusted so that the electronic device 30′ can be firmly rested on the seat 20. With reference to FIG. 6, the movably adjustable seat 20 allows users to adjust the orientation or angle of the electronic device 30 when the electronic device 30 is rested on the seat 20, so as to deliver a desirable view of a display of the electronic device 30, 30′.

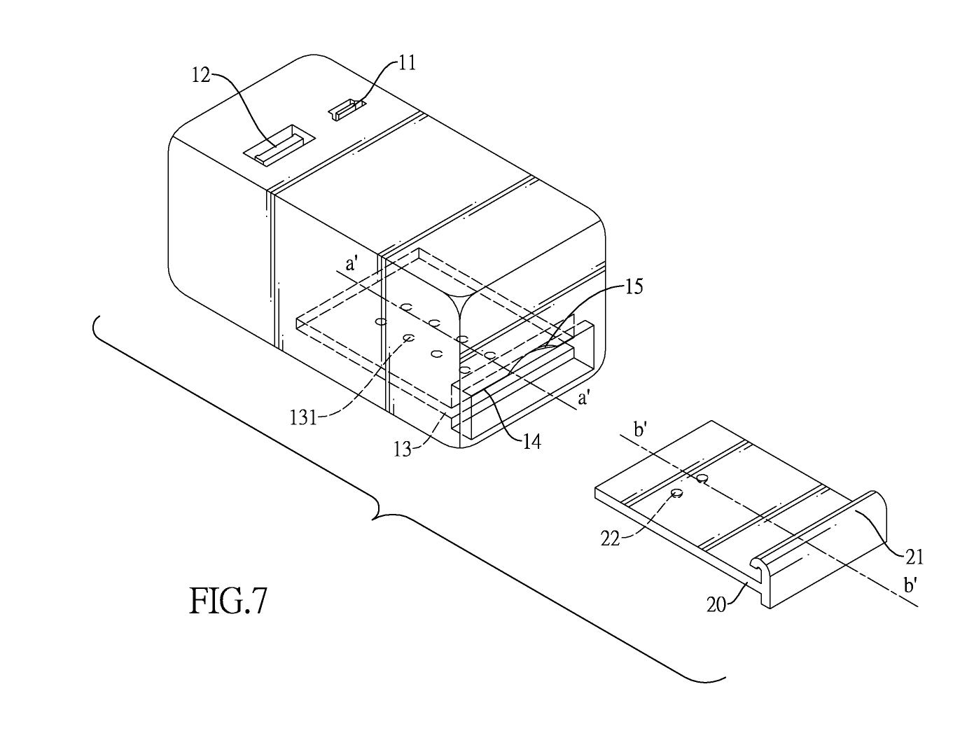

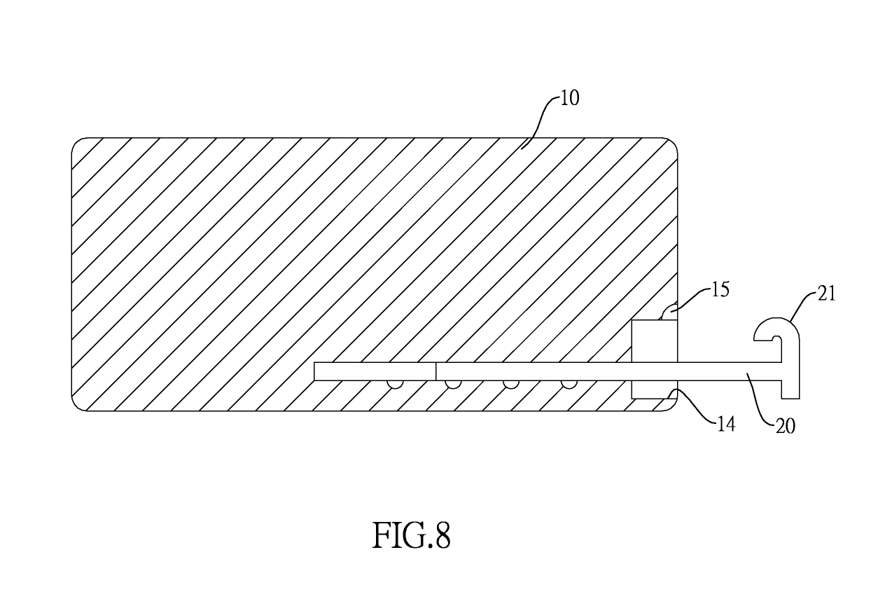

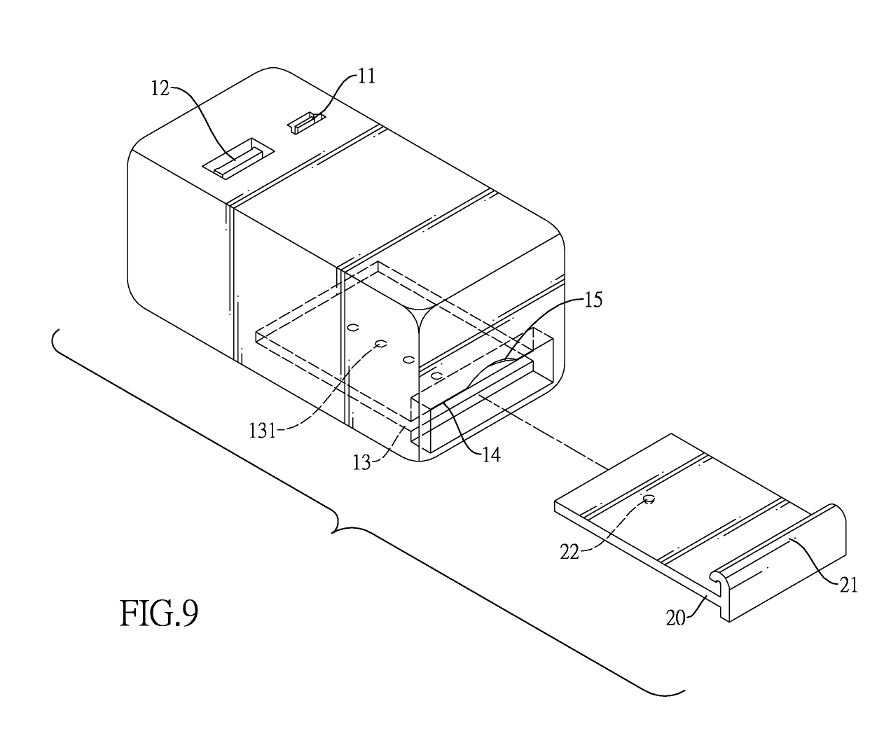

With reference to FIGS. 7 and 9, a second embodiment and a third embodiment of a charger having a retractable seat differ from the first embodiment in the first multi-sectional position limiting member and the second multi-sectional position limiting member. The first multi-sectional position limiting member has multiple dimples 131 formed in a bottom wall of the receiving slot 13 and arranged in the form of at least one straight line. With reference to FIGS. 7 and 8, the first multi-sectional position limiting member in the second embodiment of the charger has eight dimples 131 arranged in the form of two parallel lines. The dimples 131 of the two parallel lines are symmetrical to each other with respect to a center line a′-a′ of the receiving slot 13, which is parallel to the opposite inner walls of the receiving slot 13. With reference to FIG. 9, the first multi-sectional position limiting member in the third embodiment of the charger has four dimples 131 arranged in the form of a straight line parallel to the two opposite inner walls of the receiving slot 13.

The second multi-sectional position limiting member in the second embodiment and the third embodiment has at least one bump 22 formed on a top surface of the seat 20, and the at least one bump 22 selectively engages the respective dimples in the bottom wall of the receiving slot 13. The second multi-sectional position limiting member has two bumps 22 being symmetrical to each other with respect to a center line b′-b′ of the seat 20, which is parallel to the opposite sides of the seat 20, in the second embodiment and one bump 22 in the third embodiment.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A charger comprising:
a body having:
a power input port adapted to connect to and acquire power from the AC mains;
a power output port adapted to connect to an electronic device;
a receiving slot formed in and recessed from one side of the body and having a first multi-sectional position limiting member formed in at least one inner wall of the receiving slot; and
an opening formed through the side of the body to communicate with the receiving slot; and
a seat movably and retractably mounted in the receiving slot, and having:
a blocking portion formed on and protruding upwardly from one end of the seat extendable beyond the opening of the body; and
a second multi-sectional position limiting member slidably engaging the first multi-sectional position limiting member at multiple positions of the first multi-sectional position limiting member.

2. The charger as claimed in claim 1, wherein
the first multi-sectional position limiting member has multiple notches respectively formed in two opposite inner walls of the receiving slot, and at least two of the notches are formed in each of the opposite inner walls of the receiving slot, wherein the notches in the opposite inner walls of the receiving slot are symmetrical to each other with respect to a center line of the receiving slot parallel to the opposite inner walls of the receiving slot;
the second multi-sectional position limiting member has multiple ridges respectively formed on and protruding from two opposite sides of the seat, are symmetrical to each other with respect to a center line of the seat parallel to the opposite sides of the seat, and slidably engaging the respective notches of the first multi-sectional position limiting member; and
the seat further has multiple through slots formed through the seat and adjacent to the respective ridges.

3. The charger as claimed in claim 1, wherein
the first multi-sectional position limiting member has multiple dimples formed in a bottom wall of the receiving slot, and arranged in the form of at least one straight line; and
the second multi-sectional position limiting member has at least one bump formed on a top surface of the seat, and selectively engaging the respective dimples in the bottom wall of the receiving slot.

4. The charger as claimed in claim 3, wherein
the dimples of the first multi-sectional position limiting member are arranged in the form of two parallel lines, and are symmetrical to each other with respect to a center line of the receiving slot parallel to the opposite inner walls of the receiving slot; and
the second multi-sectional position limiting member has two bumps being symmetrical to each other with respect to a center line of the seat parallel to the opposite sides of the seat.

5. The charger as claimed in claim 1, wherein the blocking portion takes the form of a hook, and one free end of the blocking portion is bent toward the body.

6. The charger as claimed in claim 2, wherein the blocking portion takes the form of a hook, and one free end of the blocking portion is bent toward the body.

7. The charger as claimed in claim 3, wherein the blocking portion takes the form of a hook, and one free end of the blocking portion is bent toward the body.

8. The charger as claimed in claim 4, wherein the blocking portion takes the form of a hook, and one free end of the blocking portion is bent toward the body.

9. The charger as claimed in claim 1, wherein the depressed portion is formed in and recessed from one edge of the opening.

10. The charger as claimed in claim 2, wherein the depressed portion is formed in and recessed from one edge of the opening.

11. The charger as claimed in claim 3, wherein the depressed portion is formed in and recessed from one edge of the opening.

12. The charger as claimed in claim 4, wherein the depressed portion is formed in and recessed from one edge of the opening.

13. The charger as claimed in claim 5, wherein the depressed portion is formed in and recessed from one edge of the opening.

14. The charger as claimed in claim 6, wherein the depressed portion is formed in and recessed from one edge of the opening.

15. The charger as claimed in claim 7, wherein the depressed portion is formed in and recessed from one edge of the opening.

16. The charger as claimed in claim 8, wherein the depressed portion is formed in and recessed from one edge of the opening.
